(19) United States
(12) Patent Application Publication
(10) Pub. No.: US 2025/0375714 A1
(43) Pub. Date: Dec. 11, 2025

(54) SYSTEM AND METHOD FOR AN ELECTRONIC MUSIC POPULARITY GAME

(71) Applicant: Playlist, LLC, Tarzana, CA (US)

(72) Inventors: Shawn Krantz, Tarzana, CA (US); Blake Zingerman, Thousand Oaks, CA (US); John Eggert, Middleton, WI (US)

(21) Appl. No.: 19/234,883

(22) Filed: Jun. 11, 2025

Related U.S. Application Data
(60) Provisional application No. 63/658,618, filed on Jun. 11, 2024.

(51) Int. Cl. A63F 13/814; A63F 13/335; A63F 13/65

(52) U.S. Cl. CPC A63F 13/814; A63F 13/335; A63F 13/65

(57) ABSTRACT

A music popularity gaming system includes a backend server configured to receive, from a third-party server, information regarding songs, the information including at least one popularity metric for each song of the songs during a designated time period; transmit, to computing devices in communication with the backend server, song matchups each including at least two songs; receive, from each of the computing devices, a selection of at least one selected song matchup and a selection of a selected song; establish a contest between at least two of the computing devices; determine a winner of the contest based at least on the selected song having a greater popularity metric than the popularity metric of each other song in the selected song matchup during the designated time period; and transmit, to the plurality of computing devices, a notification of the winner.

### CROSS-REFERENCE TO RELATED APPLICATION(S)

The present application claims priority to and the benefit of U.S. Provisional Application No. 63/658,618, filed, Jun. 11, 2024, the entire contents of which are incorporated herein by reference.

### BACKGROUND

### 1. Field

The present disclosure relates generally to electronic games.

### 2. Description of the Related Art

Personal electronic devices such as mobile phones make access to music, games, and communication almost instantaneous. This is particularly apparent in the world of music, where newly released albums and songs can be retrieved almost immediately after release on streaming platforms such as Spotify and Apple Music. Many of these streaming platforms release weekly charts and algorithms every Friday, resulting in an industry standard where musicians and other artists release their new songs and albums in events colloquially known as “Music Fridays.” As a result, many consumers can readily access new releases as early as 12:00 a.m. Eastern Standard Time (EST) on Friday mornings and can listen to the new releases over a song or album's opening weekend.

Mobile and online gaming has also become a prevalent form of entertainment. Persons from different cities, regions, or even countries can compete against each other in a myriad of online games from the comforts of their own homes.

The above information disclosed in this Background section is only to enhance understanding of background information pertaining to the present disclosure and may contain information that does not constitute prior art.

### SUMMARY

The present disclosure relates to various embodiments of a music popularity gaming system. In one embodiment, the gaming system includes a backend server configured to receive, from a third-party server, information regarding songs, the information including at least one popularity metric for each song of the songs during a designated time period; transmit, to computing devices in communication with the backend server, song matchups each including at least two songs; receive, from each of the computing devices, a selection of at least one selected song matchup and a selection of a selected song; establish a contest between at least two of the computing devices; determine a winner of the contest based at least on the selected song having a greater popularity metric than the popularity metric of each other song in the selected song matchup during the designated time period; and transmit, to the plurality of computing devices, a notification of the winner.

The popularity metric may include at least a number of streams for each song during a designated time period.

The popularity metric may be stream growth rate over time, playlist inclusion, virality scores derived from social media engagement, or inclusion in editorial or algorithmic playlists.

The songs may include newly released songs.

The backend server may be configured to send API calls to API endpoints associated with the third-party server to receive the information regarding the songs.

The backend server may be configured to send, to the third-party server, a request for information regarding artist popularity; receive, from the third-party server, the information regarding artist popularity; retain a portion of the information, the portion of the information relating to songs performed by artists having greater than a threshold number of streams per month; and discard another portion of the information, the another portion of the information relating to songs performed by artists having less than the threshold number of streams per month.

The portion of the information may further relate to songs performed by artists who are projected to release new music within seven days.

The information may be artist name, song title, album title, album cover, release date, or combinations thereof.

The backend server may be configured to determine a number of projected streams in the designated time period for each of the plurality of songs; and automatically generate the plurality of song matchups such that the number of projected streams for each of the at least two songs in each song matchup is similar.

The backend server may be configured to receive, from at least one of the computing devices, a selection of two or more selected song matchups and a confident pick among the selected song matchups.

The backend server may be configured to receive, from each of the computing devices, an entry amount.

The backend server may be configured to assign the computing devices to different contests based on a number of matchups selected and the entry amount selected.

The backend server may be configured to transmit, to at least one the computing devices in communication with the backend server, a signal including full-track playback of a song in response to a selection by the at least one the computing devices.

The present disclosure also relates to various embodiments of a music popularity gaming method for users competing in a game related to song stream count. In one embodiment, the gaming method includes receiving, by a backend server from a third-party server, information regarding two or more songs, the information including at least one popularity metric for each song during a designated time period; transmitting, to two or more computing devices in communication with the backend server, song matchups each including at least two songs; receiving, from each of the computing devices, a selection of at least one selected song matchup and a selected song for the at least one selected song matchup; establishing a contest between at least two of the computing devices; determining a winner of the contest based at least on the selected song having a greater popularity metric than the popularity metric of each other song in the selected song matchup during the designated time period; and transmitting, to the computing devices, a notification of the winner.

The popularity metric may include at least a number of streams for each song during a designated time period.

The popularity metric may be stream growth rate over time, playlist inclusion, virality scores derived from social media engagement, or inclusion in editorial or algorithmic playlists.

The method may also include causing a computing device to playback a song in response to an input received by the backend server from the computing device.

The method may include causing a computing device to navigate between the song matchups in response to swipe, tap, or scroll gestures.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable device or method.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a schematic of hardware components of a music popularity gaming system, provided in accordance with embodiments of the current disclosure.

FIG. 2 is a flowchart illustrating an overview of a plurality of game steps a user takes on his or her personal computing device when playing a game enabled by the music popularity gaming system of FIG. 1, as provided in accordance with embodiments of the current disclosure.

FIG. 3 is a schematic view of a personal computing device display during a step one of the plurality of game steps of FIG. 2, provided in accordance with embodiments of the current disclosure.

FIG. 4 is a flowchart illustrating an artist propagation method, provided in accordance with embodiments of the current disclosure.

FIG. 5 is a schematic view of a personal computing device display during a step two of the plurality of game steps of FIG. 2, provided in accordance with embodiments of the current disclosure.

FIG. 6 is a schematic view of a personal computing device display during a step three of the plurality of game steps of FIG. 2, provided in accordance with embodiments of the current disclosure.

FIG. 7 is a schematic view of a personal computing device display during a step four-A and/or four-B of the plurality of game steps of FIG. 2, provided in accordance with embodiments of the current disclosure.

FIG. 8A is a table showing the estimated payout for first and second place winners of the game provided in FIG. 1, where users have selected songs from three matchups, as provided in accordance with embodiments of the current disclosure.

FIG. 8B is a table showing the estimated payout for first and second place winners of the game provided in FIG. 1, where users have selected songs from four matchups, as provided in accordance with embodiments of the current disclosure.

FIG. 9 is a schematic view of a personal computing device display during a step five of the plurality of game steps of FIG. 2, provided in accordance with embodiments of the current disclosure.

### DETAILED DESCRIPTION

Embodiments of the present invention relate generally to electronic games. The present disclosure describes, in detail, a specific embodiment with the understanding that the present invention may be susceptible to embodiments in different forms, and that the present disclosure is considered an exemplification of the principles of the invention and is not intended to limit the invention to that described herein.

The present disclosure is related to a system and method to be used in connection with an electronic game wherein a plurality of users predict a change in stream count for newly released songs in competition with other users. In accordance with embodiment of the disclosure, the system and method are computerized processes through which the users make their predictions, through which an actual popularity of the newly released songs is tracked, and through which the users may be notified of their success, or lack thereof, in relation to the predictions of other users.

As used in this disclosure, including in the claims, the system and method may be collectively referred to as the “game,” where the game preferably comprises multiple possible contests between a plurality of different users, and where each user may participate in one or more contests within the game. In other words, because the game is played virtually on electronic devices and is preferably a web and application-based game, the system may be utilized to run more than one contest simultaneously. As used in this disclosure, the term “game” may be used to broadly denote an overview of the system and method, as well as a specific game or contest in which a player is participating. The terms “games,” “contest,” and “contests” may also be used to denote one or more of the individual contests between players. Furthermore, the terms “user,” “users,” “player,” and “players” may be used interchangeably throughout the application and claims to refer to a person playing the game on an electronic device, and/or to the plurality of persons playing any of the multitude of contests operating on the system.

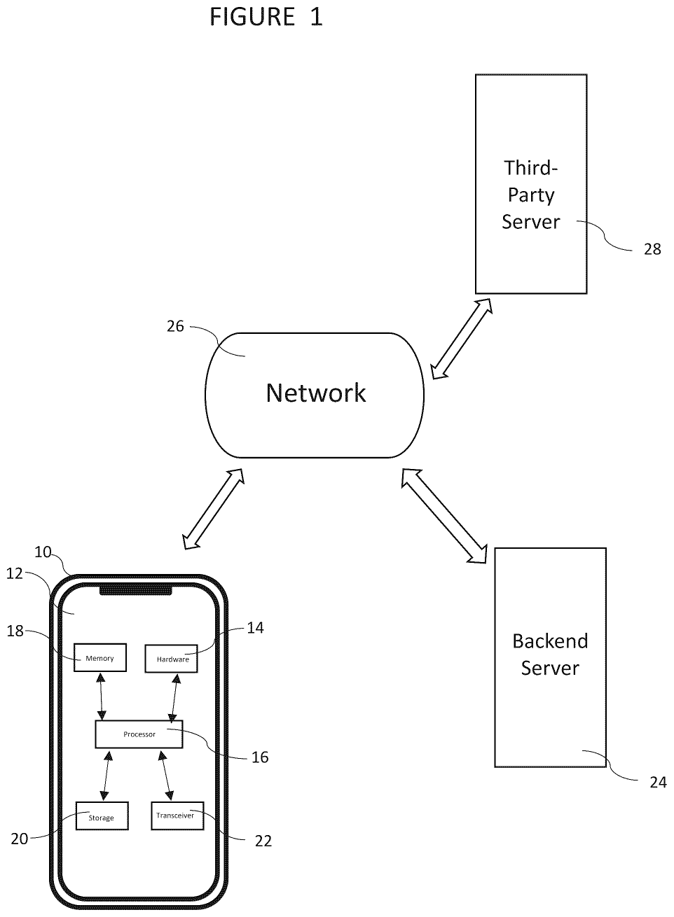

As generally shown in FIG. 1, the game is implemented through the use of a personal computing device 10, a backend server 24, and a third-party server 28. The backend server 24 functions as a repository for data, information, and programing associated with the gaming system. The third-party server 28 provides third-party data and information on, inter alia, artists, newly released songs, and stream count of those songs. In one or more embodiments, the third-party servers 28 may be DSP servers, such as, for example, servers utilized by SoundCloud®, Pandora®, Spotify®, Apple Music®, Amazon Music®, YouTube Music®, and other music streaming services. In one or more embodiments, the personal computing device 10 is a mobile device such as a smartphone or laptop. However, it is also contemplated by this disclosure that the device 10 may comprise a desktop computer, smart TV, gaming console, tablet, handheld gaming devices, or other electronic devices upon which, or with which, a user may play an electronic game. The personal computing device 10 preferably comprises a display 12, device hardware 14, processor 16, memory 18, storage 20, and transceiver 22. The display 12 may be an LCD, LED, OLED, or other type of electronic display known in the art. In one or more embodiments, the display 12 is illuminated by the processor 16, which is in turn associated with the memory 18, storage 20, and transceiver 22. The transceiver 22 preferably sends and receives digital data to and from the backend server 24 through a network 26. Similarly, data are preferably sent between the backend server 24 and third-party server 28 via the network 26. In one or more embodiments, the network 26 is an internet network 26, and is operatively associated with the backend server 24, third-party servers 28, and personal computing devices 10. However, it is also contemplated that players may play the game when in close proximity to one another and thus, it is contemplated that the network 26 may comprise a Bluetooth® network. Other types of networks for interconnecting electronic devices 10 known in the art are also contemplated by this disclosure.

In one or more embodiments, the plurality of players each utilizes his or her own personal computing device 10 to play the game. The plurality of players may preferably interact with the game from an application, or “app,” downloaded to his or her personal computing device 10. Alternatively, in some embodiments, the plurality of players may interact with the game through an online interface.

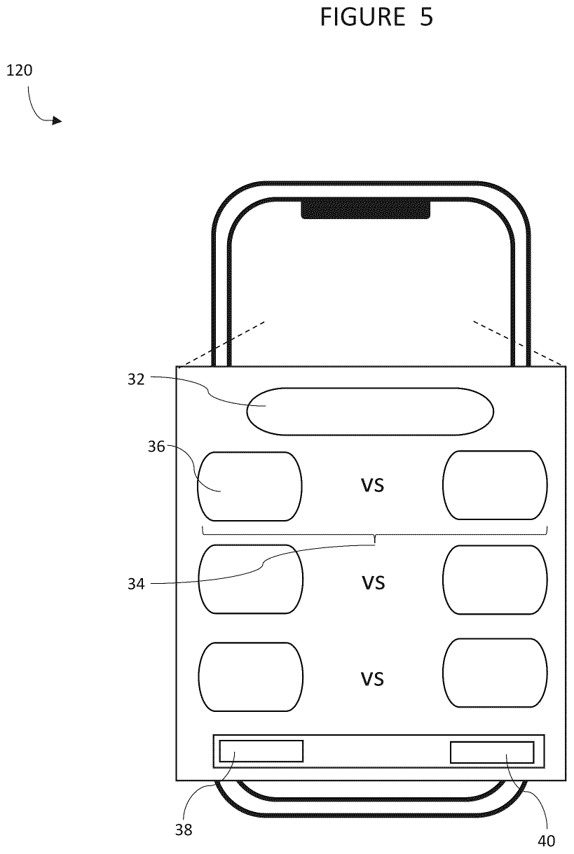

To play the game, each player may open the app on his or her personal computing device 10 and may join any of a plurality of contests. The game system is configured such that, in each contest, at least one of the plurality of users playing the game, i.e., the participating players, select a plurality of songs from a plurality of song matchups 34 exhibited on the displays 12 of their personal computing devices 10 (see FIGS. 5-7). The song matchups 34 are preferably comprised of newly released songs that the system determines have similar characteristics. The game system is further configured such that the players select which song in each selected matchup 34 the player predicts will accrue a larger stream count over a designated game period. Furthermore, the game system is configured to score contests within the game and designate game winners who, at the end of the designated game period, have correctly predicted the songs with the most streams in more than one of that user's selected matchups 34. Accordingly, winners are declared when the designated game period ends and the actual stream count for each song is revealed. In one or more embodiments, players need to correctly select the song with the most streams in two or more matchups 34 to win. In one or more embodiments, the system may utilize any other suitable popularity metric (i.e., any other suitable metric or metrics that are indicative of the popularity of a song), such as stream growth rate over time, playlist placements (playlist inclusion), virality scores derived from social media engagement (e.g., TikTok or YouTube Shorts), and/or inclusion in editorial or algorithmic playlists. In one or more embodiments, the system may utilize the total stream count in conjunction with one or more other popularity metrics. In one or more embodiments in which the system utilizes two or more popularity metrics, these popularity metrics may be weighted equally or unequally to generate a composite popularity score.

Many music charts and streaming platforms such as Spotify and Apple Music release their weekly charts and algorithms on Fridays. Accordingly, many artists choose to release their music on Fridays in an event that is colloquially known as “Music Fridays.” New musical releases are typically released at 12:00 a.m. Eastern Standard Time (EST), per industry standards. Thus, in one or more embodiments, the contests between players preferably commence on Fridays. In some embodiments, the contests commence each Friday immediately after the new songs are released at 12:00 a.m. EST. However, the contests may commence at anytime between 9:00 a.m. EST and 3:00 p.m. EST on any given Friday, affording the game system time to prepare song matchups 34. In one or more embodiments, the players would then have until 11:59 p.m. EST Friday evening to make their selections. However, it is contemplated that in some embodiments, the contests may be delayed for other periods of time after release at 12:00 a.m EST. It is also contemplated that the game may be commenced and played on different days and at different times throughout the week.

In one or more embodiments, the designated game period is the duration of a weekend. Accordingly, in one or more embodiments the contests terminate at 11:59 p.m. EST on the Sunday following game commencement, i.e., at the end of the songs' opening weekend. Alternatively, in some embodiments, the contests terminate on the following Monday to ensure time to validate streaming numbers through 11:59 p.m. EST on the preceding Monday. It is also contemplated that the designated game period may be for a duration that is shorter or longer than the opening weekend. Moreover, it is also contemplated that in some embodiments the game is commenced on other days of the week and may include artists who released songs in the preceding days, weeks, or months. It is further contemplated that the game may be played such that players make predictions on the changes in popularity for old and established songs, and that the game may include artists who released songs years or decades prior.

Game play may be described through a plurality of steps that the player takes on his or her personal computing device 10. In some embodiments, the player may be required to create an application profile, or “player account,” before the player can participate in any specific contests or games. Similarly, in some embodiments the players may select to compete for money. In those instances, players may sync a payment method to their player account. Players may deposit money into the player's account to create a “balance” for use in future or concurrent contests. The player account and player balance are preferably saved and updated in the backend server 24.

In one or more embodiments, the system may support one or more gameplay formats (i.e., gameplay modes) beyond direct song matchups. These additional gameplay formats allow for expanded user engagement and may use different or differing metrics for scoring predictions, such as streaming volume, monthly listeners, playlist inclusion, and/or social media engagement indicators.

In one or more embodiments, the system may support an “Over/Under” gameplay format or mode. In this mode, players are presented with one or more metrics for a newly released song or artist—such as stream count, monthly listeners, and/or social media followers—and must predict whether the final value of that metric at the end of the designated game period will be over or under a specified threshold. These thresholds may be dynamically generated based on trends or set by human operators, and players may be scored based on accuracy across one or multiple metrics.

In one or more embodiments, the system may support a “Streaks” gameplay format or mode. In this mode, users pick a single song each week and continue playing as long as their picks remain accurate. The streak continues until the user makes an incorrect prediction or the streak period ends. The system may support elimination-style gameplay (i.e., “last player standing”) or allow users to compete over a fixed period of time, such as four or eight weeks, with prizes distributed based on the longest correct streak.

In one or more embodiments, the system may support a “Draft Team” gameplay format or mode. In this mode, players are given a virtual budget to draft a team of artists (e.g., singers or bands). Each artist is assigned a value based on past and future metrics that may include streams, monthly listeners, popularity across social channels, etc. Players' teams accumulate points throughout the contest duration based on cumulative streaming numbers, chart positions, and/or engagement metrics of their drafted artists. In one or more embodiments, this gameplay mode may utilize a salary cap mechanism that ensures strategic diversity and prevents all users from selecting only top-tier artists.

In one or more embodiments, the system may support a “Artist Stock Market” game format or mode that allows users to simulate buying and selling shares of artists (e.g., singers or bands). Share prices may be dynamically adjusted based on streaming trends, chart movement, and/or algorithmic valuations. Users are ranked based on their portfolio value at the end of a game period. In some embodiments, share value fluctuation is updated live, daily or hourly using real-time API data.

In one or more embodiments, the system may support a “Historic Comparison” gameplay format or mode. In this mode, users predict whether a new release will outperform or underperform a previous song or album by the same artist. The system may display historical streaming data for comparison. Users may be presented with data visualization tools or reference stats to guide their predictions.

In one or more embodiments, the gameplay modes may support variations in the number of picks per entry. In some embodiments, players may choose 1, 2, 3-4, or 5-6 songs per contest, with payouts scaled based on difficulty. The backend system dynamically groups users into pools based on their entry type to ensure fair payout distributions. In some embodiments, increased picks may unlock bonus multipliers or side prizes.

The above-described gameplay formats may be presented to users as selectable contest types during the entry process or they may be run as limited-time game events. Metrics used to determine winners in these games may include total stream count, stream growth rate, monthly listeners, social media engagement, playlist placements, and/or other popularity indicators as pulled from third-party APIs. The inclusion of these formats allows the system to operate multiple simultaneous contests appealing to different player preferences and engagement styles.

Once the player has created an account, the player may select a game or contest

in which he or she wishes to compete. Alternatively, in some embodiments, the player may commence game play immediately upon opening the app and will be assigned to a contest based on selections that he or she makes at each step. In some embodiments, finalizing the player's selections at each step will trigger a change in the material presented on the computing device's 10 display. In other words, the display 12 presents a new “screen” at each of the plurality of steps. However, in other embodiments, the display 12 may present all material necessary to complete two or more steps at the same time, and the player may make multiple selections on the same screen.

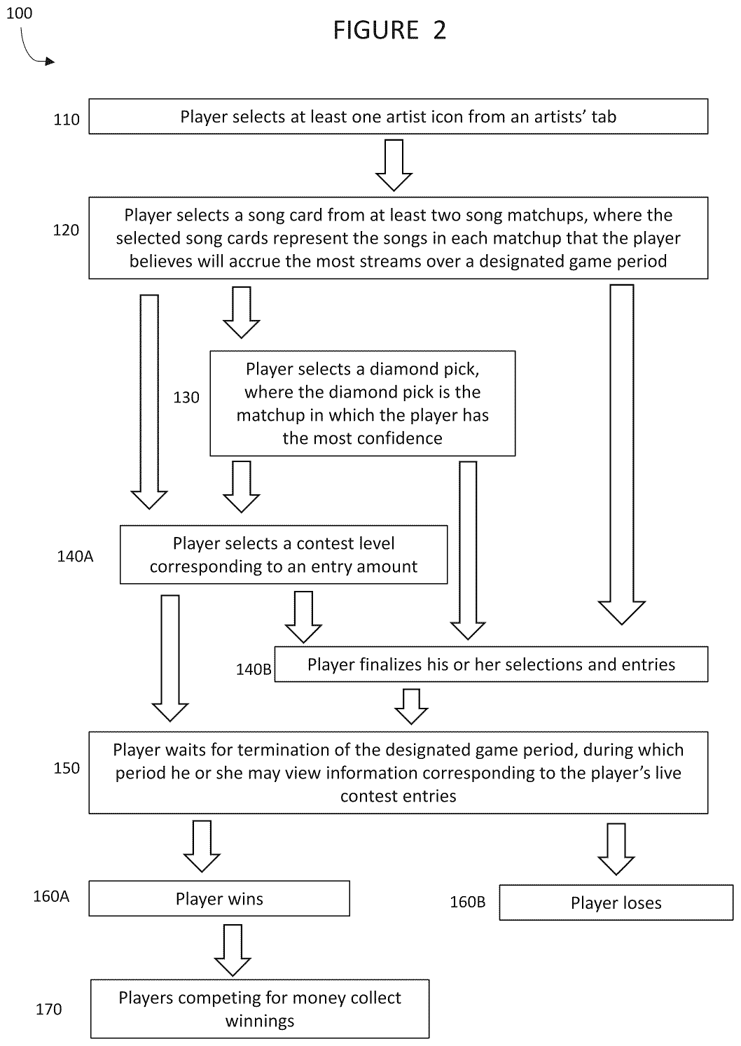

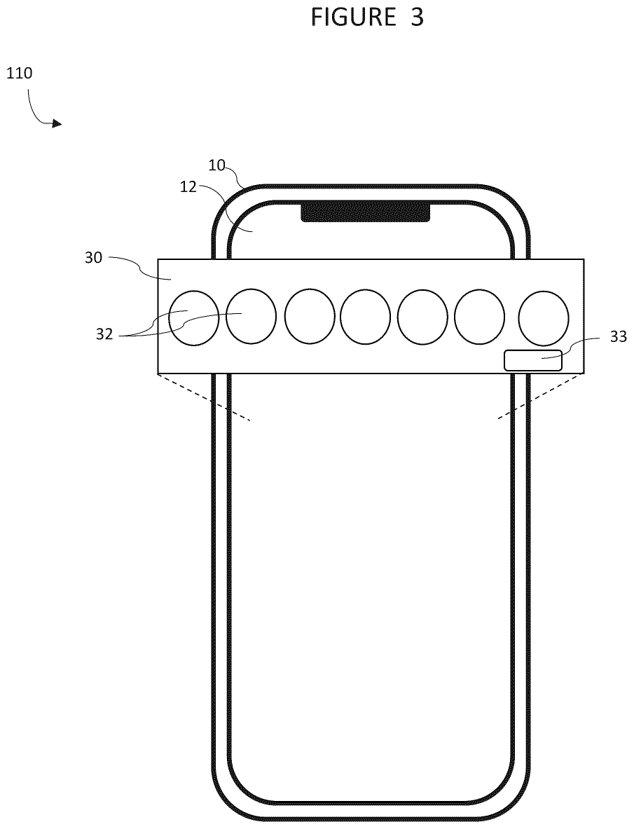

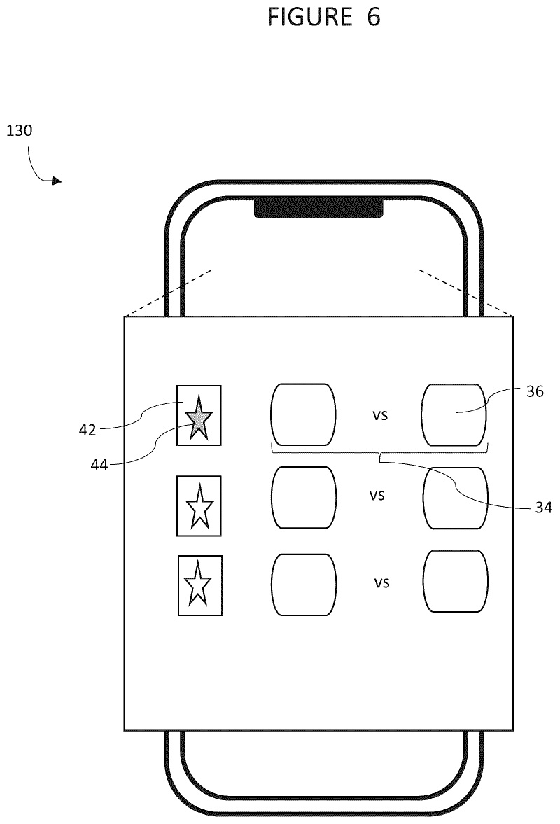

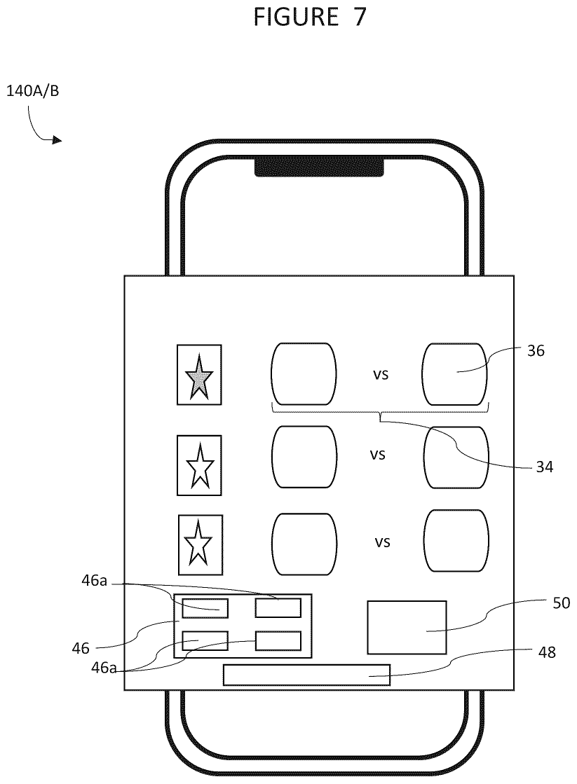

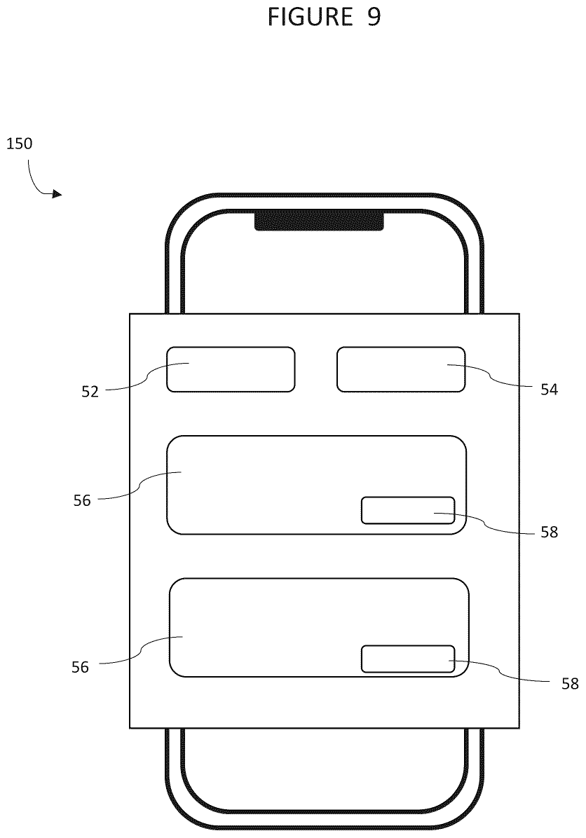

FIG. 2 is a flowchart illustrating an overview of a plurality of game steps 100 that the player takes on his or her personal computing device 10 when playing the game, in accordance with one or more embodiments. In step one 110, the player selects from an at least one artist's icon 32 from an artists' tab 30 (see FIG. 3). The player then selects a song card 36 from at least two song matchups 34 presented in step two 120 (see FIG. 5). In one or more embodiments, each song card 36 that the player selects represents a song from the associated matchup 34 that the player believes will accrue the most streams over the designated game period. In some embodiments, the player may then proceed to step three 130 (see FIG. 6), where the player selects a diamond pick representing the matchup 34 in which the player has the most confidence. In some embodiments, the player may then proceed to step four-A 140A, where the player selects a contest level 46 and an entry amount 46a (see FIG. 7). In step four-B 140B, the player finalizes his or her selections and entries (See FIG. 7). In some embodiments, the player may proceed to step four-A 140A directly from step two 120 and does not select a diamond pick. Similarly, in other embodiments, the player may proceed directly to step four-B 140B from step two 120 and does not select a diamond pick or a contest level 46. In some embodiments, the player may finalize his or her selections and entries in step four-B 140B directly after selecting his or her diamond pick in step three 130 and does not select a contest level 46. Moreover, in some embodiments, the player finalizes his or her selections by choosing a contest level 46 and does not need to finalize his or her selections in a separate step four-B 140B. In such instances, the player may proceed directly from step four-A 140A to step five 150. In step five 150, the player waits for the termination of the designated game period. During that time, and in some embodiments, the player may view information corresponding to the player's live, or active contests 56. When the designated game period has ended, the player may be declared a winner in step six-A 160A if he or she has successfully predicted which song in each selected matchup 34 accrued the most streams, or if he or she predicts all but one matchup 34 and also correctly predicts his or her diamond pick. If a player does not correctly predict all matchups 34 or does not correctly predict his or her diamond pick as well as all but one matchup 34, then the player loses in step six-B 160B. Winning players who compete for money may collect their winnings in step seven 170 (see FIG. 9).

FIG. 3 illustrates a player's display 12 during step one 110 of the game in accordance with one or more embodiments of the current disclosure. During step one 110, the display 12 exhibits the artists' tab 30, upon which the plurality of artist's icons 32 are presented. The artist's icons 32 preferably show identifying information for artists who meet criteria for inclusion in the game. In one or more embodiments, an artist may meet these criteria if he or she has released new songs or albums on that Music Friday. Other criteria may include artist general popularity, as measured by the number of persons who listen to the artist per month, popularity of the artist's most recent releases, the artist's chart performance, whether the artist is trending on social media, whether the artist has won any awards or nominations, and other indicators of artist popularity and/or quality. A player may select an artist by clicking, tapping, or pressing and holding on the artist's icon 32, or by other methods known in the art for selecting items on personal computing devices 10. In some embodiments, between 1 and 20 artists are exhibited on the artists' tab 30 for player selection. In other embodiments, between 8 and 20 artists are available for player selection. However, it is contemplated that in some embodiments the game may present more than 20 artists for player selection. In some embodiments, between 5 and 10 artists are exhibited upon the artists' tab 30 and the player may select a “view all,” or similarly designated button 33, to view a full list of all participating artists. In one or more embodiments, the between 5 and 10 artists are exhibited in a carousel style format in descending order based on popularity pulled from the third party server 28. When the player clicks “view all,” the between 5 and 10 artists are preferably exhibited in a grid layout along with all other qualifying artists.

In one or more embodiments, the system interface enables users to interact with song matchups through gesture-based navigation. Players may swipe left or right to browse through different matchups, and tap to select a song for inclusion in their lineup. In some embodiments, users may tap once to add a song to their lineup, or press and hold (i.e., long press) to listen to a song in real time, with playback continuing for the duration of the press and stopping upon release. This dual-function gesture system provides an intuitive and immersive experience by combining selection and previewing functionality into a seamless interface.

Some embodiments may additionally or alternatively comprise a dynamic search bar wherein the player may search for particular artists or may select artists based on genre, mood, recent activity, and/or other selection criteria or preferences. In one or more embodiments, the artists are exhibited upon the artists' tab 30 on circular icons 32 with the artists' images and names. However, in other embodiments, the artists may be exhibited on square or other polygonal shaped tiles, may be exhibited with just the artists' names or just the artists' images, or may be presented via an abstract representation of the artist.

In some embodiments, the game exhibits information about the artists for player review. The information may include the date of the artists' most recent releases, the artists' biography and/or discographies, recent news related to the artists, snippets of the artists' music and/or music videos, snippets of live performances, interviews, and/or other public information related to the artists and/or their songs and albums. The artists' information may be present on the artists' icons 30 or may be reviewed in a pop-up screen. In some embodiments, the pop-up screen is accessed by clicking or hovering over a specific artist's icon 32 when the player is using a computer or other electronic device that utilizes a mouse, by pressing and holding on the artist's icon 32 when using a mobile device such as a phone or tablet, by quickly tapping on the artist's icon 32 when using a mobile device, or by other methods readily apparent to those skilled in the art. The pop-up screen may also present moving images or animations upon the player's selection of the artist.

Artist propagation in the artists' tab 30 is contingent upon the artist meeting the required criteria. In one or more embodiments, the game pulls artists from the backend server 24 based on whether that artist will, or has, released new music within a set time period. In one or more embodiments where games commence on Music Fridays, data stored in the backend server 24 is propagated during the preceding seven days.

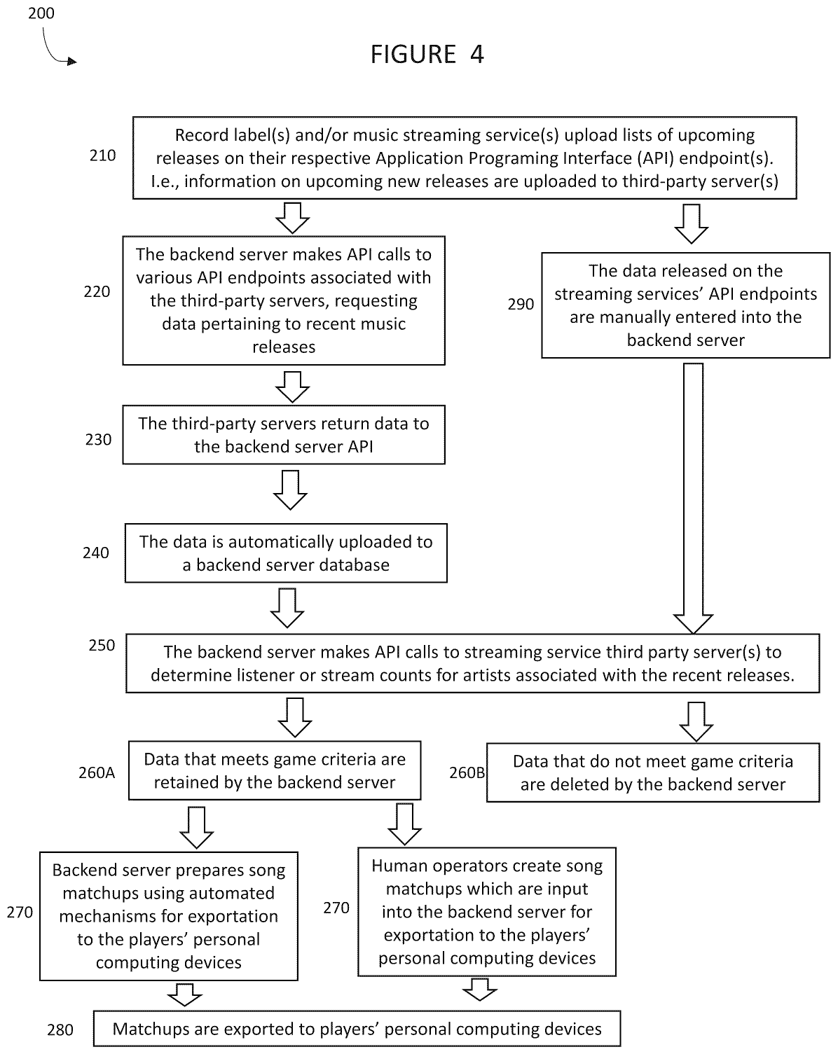

FIG. 4 is a flowchart illustrating an artist propagation method 200 utilized in one or more embodiments to acquire artist information and create song matchups 34. A generally known in the art, record labels and music streaming services upload lists of upcoming releases to their respective Application Programing Interface (API) endpoints. APIs are generally used to facilitate communication between two or more computer programs, which may communicate through what is termed “API calls,” wherein a message is sent to a server asking an API to provide a service or information. Thus, in one or more embodiments, a first propagation step 210 comprises third-party record labels uploading information regarding upcoming releases to associated third party server 28 API endpoints. Alternatively, or additionally, the first propagation step 210 may comprise third-party steaming services uploading information to associated third-party servers 28. In a second propagation step 220, the backend server 24 makes API calls to the various third-party server 28 API endpoints and requests data pertaining to recent music releases and associated artists. The third-party servers 28 return the requested data to the backend server 24 in a third propagation step 230. In a fourth propagation step 240, the data returned to the backend server 24 is uploaded to a backend server database. Alternatively, data released on the streaming service or record labels' API endpoints may be manually entered into the backend server 24 in a manual propagation step 290. In other words, the data may be either automatically or manually uploaded to the backend server 24. In one or more embodiments, the backend server 24 then makes an API call to streaming service third-party servers 28 in a fifth propagation step 250 to determine monthly listener counts for the artists that correspond to the recent release data acquired from the record label APIs. In a sixth propagation step 260A, data that meets a plurality of game criteria is retained and saved by the backend server 24, while data that does not meet the game criteria is deleted in propagation step 260B. The data are then used to create song matchups 34 for newly released songs in a seventh propagation step 270. This may be done through an automated mechanism, or through the efforts of human operators. Once the matchups 34 are created, they are exported to the players' personal computing devices 10 in an eighth propagation step 280.

The information acquired in the first propagation step 210 typically includes associated data for each upcoming release, including, but not limited to, the artist's name, song and/or album titles, album covers, and release date. Third-party data and data associated with upcoming releases may be retrieved directly from record labels and/or streaming services, but it is also contemplated that third-party data may be obtained from other third-party-servers 28, such as those associated with third-party aggregators or those utilized in web scraping.

In the second propagation step 220, the backend server 24 preferably makes API calls to the various API endpoints associated with the third-party servers 28 requesting data pertaining to recent music releases. In response, the third-party servers 28 returns data stored in the third-party server 28 endpoint to the backend server 24 API. The data are then automatically uploaded to the backend server 24 database in the fourth propagation step 240. Alternatively, in some embodiments the system does not utilize the second, third, or fourth propagation steps 220, 230, 240, and data released on the streaming services' API endpoints are manually entered into the backend server 24. Either way, once the data pertaining to new releases is uploaded to the backend server 24, the backend server 24 makes API calls to the streaming service(s) third-party server(s) 28 in the fifth propagation step 250 to determine the popularity of the releasing artists for use in the sixth propagation step 260.

In the sixth propagation step 260, data that meet the game criteria are retained by the backend server 24 while data that do not are deleted. In some embodiments, the backend server 24 only retains information for artists who are projected to release new music within seven days and who have over a million monthly listeners (as determined in the fifth propagation step 250), so long as the number of artists who meet these criteria is above a predetermined threshold. For instance, in one or more embodiments, the game presents at least eight artists for player selection. Thus, if fewer than eight artists releasing new songs have over a million monthly listeners, the backend server 24 will preferably keep the top eight artists with the most monthly listeners, regardless of whether those eight artists have more than a million monthly listeners. It is contemplated that in some embodiments, the predetermined artist retention threshold is greater or less than eight artists, and that in some embodiments the general popularity threshold may be below or above one million listeners. It is also contemplated that the general popularity threshold may be determined by number of streams, rather than number of listeners, or by other metrics that measure the popularity of an artist. It is further contemplated that in some embodiments, propagation of the artist database within the backend server 24 may be accomplished through other methods that utilize communication between the third-party server 28 and backend server 24 via the network 26.

Once the backend server 24 has acquired artist data from the third-party server 28, the backend server 24 prepares song matchups 34 for exportation to the players' personal computing devices 10. Song matchups 34 may be of songs released by the same artist, or of songs released by different artists. In one or more embodiments, the system matches songs that the system predicts will have similar opening weekend stream counts, based on opening night streams, similarities in song quality, genre, track list placement, artist popularity, and/or other metrics known in the art.

In some embodiments, song matchups 34 are prepared by human operators using the backend server 24. In these embodiments, human operators review each song propagated from communication with the third-party servers 28 and identifies track list order, song features, catchiness, virality potential, popularity of the artist, and/or other metrics known in the art for identifying a potential popularity for a song. The human operators then manually input data into the backend server 24 regarding an anticipated potential global stream count for each song. In other words, the human operators create matchups 34 between songs that the human operators believe will have similar streams over the designated game period. In one or more embodiments, to create the matchups 34, the human operators designate the song title and album as “objects,” on a cloud database such as AWS DynamoDB where the song title is designated as the object's “primary key” and the song artist is recorded as the object's “sort key.” In one or more embodiments, the matchups are stored in a cloud database.

In other embodiments, the song matchups 34 are prepared using automated mechanisms that are coded in the backend server 24. In some embodiments, artificial intelligence is used to prepare the song matchups 34. The automated mechanisms “listen” to every song in an artist's album and ranks the songs based on factors such as song catchiness, virality potential, popularity of the artist, and/or other metrics known in the art for identifying potential popularity of a song. The automated mechanisms then create a score for each song based on these factors and create matchups 34 between songs with similar scores, i.e., that the system predicts to have competitive opening-weekend streaming performances. In some embodiments, matchups may be generated between songs from the same album, while in other embodiments, songs may be selected from different albums by the same or different artists. This allows flexibility in gameplay format depending on the structure of new releases and contest design preferences. In some embodiments, human operators check and approve the matchups 34 generated by the automated mechanisms before the matchups 34 are exported to the players' personal computing devices 10. In one or more embodiments, the song matchups 34 may be prepared using automated mechanisms that are coded in the backend server 24. In some embodiments, artificial intelligence is utilized to prepare the song matchups 34. The automated mechanisms “listen” to every song in an artist's album and rank the songs based on factors such as, for example, song catchiness, virality potential, popularity of the artist, and/or other metrics known in the art for identifying potential popularity of a song. The automated mechanisms then assign a composite score to each song based on these factors. In one or more embodiments, the weight assigned to each factor may vary depending on the selected game mode. For example, a mode focused on virality may weigh social media indicators more heavily than a mode focused on early stream count, tracklist placement, or featured artists. Matchups 34 are then generated between songs with similar composite scores (e.g., within the same range of composite scores), which the system predicts to have competitive performances under the applicable game criteria. In some embodiments, matchups may be generated between songs from the same album, while in other embodiments, songs may be selected from different albums by the same or different artists. This allows flexibility in gameplay format depending on the structure of new releases and contest design preferences. In some embodiments, human operators check and approve the matchups 34 generated by the automated mechanisms (e.g., artificial intelligence) before the matchups 34 are exported to the players' personal computing devices 10.

Once the song matchups 34 are generated, the matchups 34 and associated song and artist data are preferably transferred to the player's personal computing device 10. In one or more embodiments, upon the player selecting an artists' tab 30, the player's personal computing device 10 makes an API call to the backend server 24 with the selected artist's name attached to the request. The backend server 24 then provides the song and artist data for all matchups 34 containing songs by that artist. In one or more embodiments, data are transferred between the third party server 28, the backend server 24, and the player's personal computing device 10 in JSON format. However, other formats of data transfer known in the art are also contemplated by this disclosure.

Once a player selects an artist in step one 110, the player is preferably prompted to proceed to step two 120 of the game. A schematic illustrating the display 12 during step two 120 is shown in FIG. 5. In step two 120, the player is presented with a plurality of song matchups 34. In one or more embodiments, each matchup 34 presented to the player contains at least one song recently released by the artist selected in step one 110. In one or more embodiment, the songs of each matchup 34 are presented on the song cards 36. Each song card 36 preferably exhibits identifying information for the song and associated artist. The information presented on the song cards 36 may include song title, album, album artwork, artist name, and/or a play button that allows the player to play a snippet of the song. In some embodiments, the system allows full-track playback directly within the application interface, enabled through licensed or authorized music integrations via embedded streaming APIs, local caching, or hosted media. Each matchup 34 presents at least two song cards 36 to the player, who must select which of the at least two songs the player believes will have a higher streaming number at the end of the designated game period. The player may tap, click, or otherwise select the song card 36 that contains the song which he or she predicts will have the most streams. In one or more embodiments, selected song cards 36 will be outlined, illuminated, enlarged, and/or will otherwise become visually distinct. In one or more embodiments, the display 12 additionally presents a selection tracker 38 wherein the number of selected songs is presented for the player. Selecting a song adds the song's data to a programming object stored on the player's personal computing device 10 which stores the list of selections. In some embodiments, the data for each song includes image URL, title, artist, and/or other song information. In some embodiments, if a player wishes to make changes to his or her selections, the player may click, tap, or otherwise deselect a selected song, thereby removing the song from the list of selections. In some embodiments, when the player has finished making his or her selections, the player may hit a finalization button 40 on the display 12 to move to the next step in the game. In one or more embodiments, the finalization button 40 contains text that reads “finalize entry,” “next,” “finished,” or other similar terminology to indicate that the player has completed making selections. In some embodiments, players may be required to select songs from at least two different artists. In other embodiments, the game may allow all selected matchups to be from a single artist. This optional constraint may vary based on contest type, desired difficulty, or promotional structure. In some embodiments, the finalization button 40 is not operable until the player has selected at least two songs.

In one or more embodiments, the matchups 34 each contain two song cards 36. However, in other embodiments, the matchups 34 may contain three to six song cards 36. The player must select at least two songs, one from at least two different matchups 34. In some embodiments, the player may select songs from between two and four matchups 34, although it is contemplated that in some embodiments the player may select songs from more than four matchups 34. In some embodiments, players may select from matchups 34 that all contain at least one song from the same artist. In other embodiments, players may select matchups 34 from different artists. Moreover, in some embodiments, each matchup 34 may be between two or more songs released by the same artist. In other embodiments the matchups 34 may be of one or more song by the selected artist and one or more songs released by another artist.

FIG. 6 is a schematic illustrating the display 12 during an optional step three 130 where players identify the selected song card 36 in which they have the most confidence. The selected song card 36 may be referenced as the “preferred pick,” “diamond pick,” “platinum pick,” or other similar term. For use in this disclosure, the song card 36 selected as the player's most confident pick is referred to as the “diamond pick.” In some embodiments, the player may select his or her diamond pick by simply re-clicking on the song card 36 after the game has proceeded past the initial selections stage in step 120. In other embodiments, the display 12 presents the player with a diamond pick box 42 during step three 130. In some embodiments, the diamond pick box 42 comprises a check box. In other embodiments, the diamond pick box 42 contains an icon 44 with an image such as a star or diamond, and selection of the diamond pick box 42 results in the icon 44 becoming visually distinct through highlighting, outlining, enlarging, or otherwise altering the image to become visually distinct.

FIG. 7 illustrates a screen where players may select their contest level 46 and entry amount 46a, and where players may finalize their entries using a place entry button 48. In some embodiments, the player may select the song cards 36 for all desired matchups 34 on the same screen that the player selects his or her diamond pick and contest level 46. In other words, the player may complete steps 120, 130, and/or 140A on the same screen. However, in other embodiments, each step, or any number of step combinations, are presented on separate screens. Some embodiments additionally present a place entry button 48 in step four-B 140B. Alternatively, in some embodiments the player finalizes his or her picks on a separate screen. In some embodiments, to finalize his or her entry, the player must select a contest level 46. In some embodiments, the player may select that he or she wishes to play for money. In such instances, the contest level 46 relates to an entry fee. In these embodiments, the player is preferably presented with a plurality of entry amounts 46a, where the entry amounts 46a correlate to various money amounts. In embodiments when the player selects an entry amount 46a, the display 12 will present a prize pool 50 which shows how much the player can expect to win if he or she is successful.

In one or more embodiments, the prize pool 50 is disclosed prior to the contest being filled and it does not vary (change) based on the number of players within a contest. In one or more embodiments, the prize pool 50 may be based on the number of matchups 34 the player selected, the entry amount 46a the player selected, and the number of contestants who have entered the contest. In other embodiments, the player may select to not play for money but may still pick an entry amount 46a, where the entry amount relates to some other metric related to the player's chances of success, such as the number of players included in a contest. Alternatively, in embodiment where the player does not play for money, the player may instead play for “fake money,” where the player still selects an entry amount 46a that corresponds to a dollar amount, but where no actual money is invested in the game.

In some embodiments, the player may finalize his or her selections by selecting

an entry amount 46a. However, in other embodiments, the player must select the contest level 46 and must also click on the place entry button 48 to finalize his or her selections. In still further embodiments, the player may skip selection of the contest level 46 and may finalize his or her entry by simply clicking the place entry button 48. The place entry button 48 may contain words such as “place entry,” “finalize,” “finish,” or a similar word, phrase, or symbol to indicate that the player is finalizing his or her selections and is ready to enter contests with other players.

In one or more embodiment, the system presents between four and six entry amounts 46a for player selection. However, it is contemplated that in some embodiments, the system may present fewer than four entry amounts 46a or more than six entry amounts 46a. In some embodiments, the entry amounts 46a may range from $0 to $100. In one or more embodiment, the entry amounts 46a are $5, $10, $15, and $20. However, other amounts and ranges are contemplated, and some embodiments may present entry amounts 46a of any amount up to, equal to, or greater than $100.

In some embodiments, the player accrues points, or “Diamonds,” each time he or she finalizes his or her selections and enters a contest. These Diamonds amount to in-game currency and may be accrued through multiple contests. Each Diamonds equates to a specific money amount, and when the player has collected enough Diamonds, he or she may use those Diamonds in lieu of money to play in money contests.

Players are placed into contests based on the number of matchups 34 he or she

has selected and based on the selected contest level 46. In one or more embodiments, once a player has finalized his or her entries, data associated with the player's selections are transferred to the backend server 24 via an API request and call. The backend server 24 preferably stores a database of contests where the contests are distinguished by matchup 34 number and contest level 46/entry amount 46a, i.e., the “entry specifications” for each player included in the contest. In some embodiments, each contest may include between five and fifty players. In one or more embodiments, contests include twenty-five players. However, it is also contemplated that in some embodiments, each contest may include between two and 10,000 players, or that contests may include more than 10,000. If all contests matching a player's entry specifications are full, the backend server 24 facilitates creation of a new pool database and pool ID.

When a player is added to a contest, data associated with the player's account, such as the user's name, or other identifying information and email, are added to the contest data saved on the backend server 24. Data associated with the player's selections, such as the specific song and matchup 34 picks and entry amounts 46a, are also saved to the backend server 24 in connection with the specific contest to which the player is added. In instances where the players are competing with money, each contest preferably has an entry fee and a “pool,” where the pool equates the number of players participating in the contest multiplied by the entry fee for admission into the contest. In one or more embodiments, the entry fee equates to the entry amount 46a that the player selects in step four-A 140A. When a player is added to the contest, the number of entries attributed to each pool is increased by one, the user's balance saved under the user's account in the backend server 24 is decreased by the contest's entry fee, and the pool is increased by one increment of the entry fee.

Contest winners are determined at the end of the designated game period when the actual stream count for each newly released song is determined. As used in this disclosure, the term “winner” or “winners” refers to each player who has successfully met the criteria for first or second place. There can be multiple first and second place winners in each contest. In one or more embodiments, to get first place in a contest, the player must be correct in each of his or her song selections. In other words, the player must have selected the song cards 36 that represent the songs with the higher stream count in each matchup 34 that the player selected. Alternatively, in some embodiments a player can win a second-place score if he or she correctly predicts his or her diamond pick and all but one of his or her other matchups 34. For instance, if the player picks songs from three matchups 34, he or she can win second place if he or she correctly predicts his or her diamond pick and one other song. If the player picks songs from four matchups 34, he or she can win second place by correctly predicting the diamond pick as well as two other songs. Thus, the more matchups 34 the player selects, the more difficult it is for the player to correctly predict which song will have the higher streams, and the less likely it is that the player will win.

Accordingly, the more matchups 34 that each player selects from, the fewer first and second place winners and the higher the payout. For example, in contests where each player selected songs from two matchups 34, a first-place winners can expect to receive a payout that is two times the entry amount 46a. In contests where the players have selected songs from three matches 34, a first-place winner can expect to receive a payout that is four times the entry amount 46a. In contests where the players have selected songs from four matches 34, a first-place winner can expect to receive a payout that is eight times the entry amount 46a.

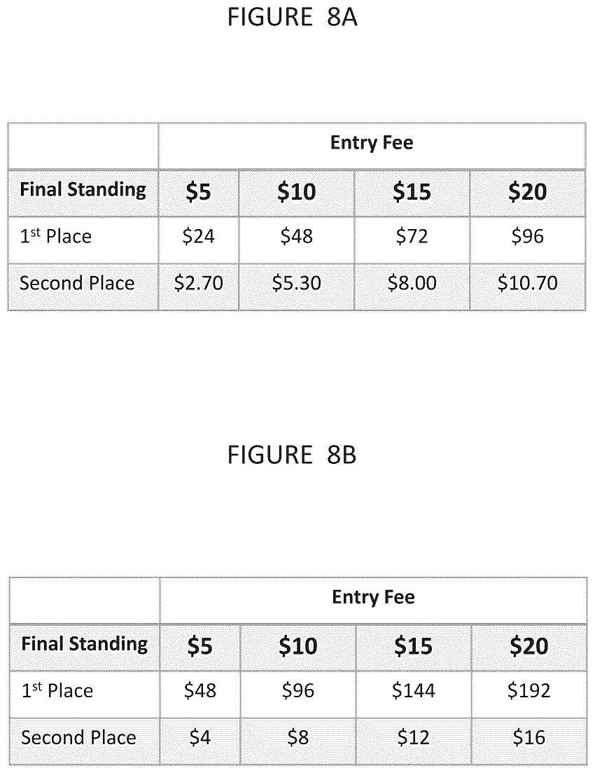

For further exemplification, FIG. 8A presents a table showing the estimated payout for first and second place winners in contests where the players have selected songs from three matchups 34. The estimated payouts in FIG. 8A are for players who have selected a $5, $10, $15, or $20 entry fee. Similarly, FIG. 8B shows example payouts for players who selected songs from four matchups 34. These example payouts are presented as examples only, and it is contemplated that other payout systems may be used. For instance, in one or more embodiment, payouts are reduced by a house commission fee.

Once players have made their selections and have entered a contest, they must wait until the end of the designated game period to determine the outcome. FIG. 9 is a schematic illustrating the display 12 during a step five 150 of the game, wherein the players may view their live contest entries and corresponding information. At this point, the players have already selected and submitted their selections and are waiting for the actual stream counts for their selected songs. During this waiting period, players may access the app to view the specifics of each of their active contests 56 by selecting an active contests button 52. The active contests button 52 may alternatively be titled “Live Entries” or some other similarly designated alternative. In some embodiments, the player may also, or alternatively, view past entries by clicking a past entries button 54. When the player clicks on the active contests button 52, the device 10 will present a screen showing each of the active contests 56 in which the player is contemporaneously competing. Some embodiments further include a view entry button 58 for each live entry, which the player can click to see information corresponding to that contest and to the player's current standing. When a player opts to view a specific entry 56, the player will be able to see information including, but not limited to, the player's current standing in the contest in question and whether or not the player is on-track to win. Other information disclosed may also include the matchups 34 and songs picked by other players in the contest, and the stream counts of all entries selected by the plurality of players in the contest. However, in other embodiments, players only be able to review information pertaining to their own picks and will not be able to see stream counts for selections made by other players in the contest.

In one or more embodiments, when a player elects to view active or past contests, the player's device 10 sends an API call to the backend server 24 requesting data for all saved entries associated with the player's identifying information. In some embodiments, the player's current and past entries are saved to the backend server 24 in connection with the player's email address. In one or more embodiments, the backend server 24 then returns data associated with all entries matching the identifying information provided by the player's device 10.

Stream counts that players may review in the active contests 56 screen may be propagated as live stream counts. In other embodiments, stream counts are propagated a select number of times per day. In embodiments where players may view the live stream count of their selections and/or of the selection of other players in their contests, the backend server 24 sends an API request to the third-party servers 28 associated with stream data providers every few seconds. In some embodiments, the backend server 24 sends API requests for stream counts every 1 to 10 seconds. In other embodiments, the backend server 24 sends API requests for stream counts every time a player manually refreshes the player's active contests 56 screen on his or her personal computing device 10. In some embodiments, to propagate a request for stream counts, the player's device 10 sends a list of all song names to the stream count provider's third-party server 28. The third-party server 28 looks up the stream counts associated with the requested songs and returns the counts to the user's device 10. Alternatively, in some embodiments, the system only makes stream count requests between one and ten times a day.

In some embodiments, when a player clicks the active contests button 52, a new screen is propagated on the player's device 10 that displays information related to all the player's active contests 56. In some embodiments, this information may comprise general contest information including, but not limited to, the number of matchup 34 selections required for inclusion the that specific contest, the total cash value of the prize pool 50, the number of participants in that contest, the number of participants winning the contest, and/or the time remaining until the contest ends. The information may also comprise player specific information including, but not limited to, the artists that the player selected, the song cards 36 that the player selected, the live standing of the player's selections displaying the player's selected songs in comparison with the competing songs, live stream counts for the songs in each of the player's selected matchups 34, and/or an indication of whether player is winning or losing. In some embodiments, the device 10 may present information for each player participating in the active contests 56, including usernames, emails, profile pictures, and status in the contest (i.e., whether the players are winning or losing). In other embodiments, only the usernames and status for each player will be displayed. In still other embodiments, additional information for each competing player may be displayed.

Once the designated time period for a contest ends, the backend server 24 reads each active entry that it has stored and determines the winners of each contest by scanning each player's stored song picks from their selected matchups 34 and validating whether the player had successfully selected the song with the most streams. The backend server 24 thus determines a list of winning players and divides the prize pool 50 by the total number of winning entries. The players' winnings are then distributed into the winning players' accounts. The players may then elect to use those winnings to play other contests or may connect a bank account to their system account for a transfer of funds.

While the invention is described through the above-described exemplary embodiments, modifications to, and variations of, the illustrated embodiments may be made without departing from the inventive concepts disclosed herein. For example, although specific parameter values, such as dimensions, materials, additives and coatings, may be recited in relation to disclosed embodiments, within the scope of the invention, the values of all parameters may vary over wide ranges to suit different applications.

As used herein, including in the claims, the term “and/or,” used in connection with

a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Although aspects of embodiments may be described with reference to flowcharts and/or block diagrams, functions, operations, decisions, etc. of all or a portion of each block, or a combination of blocks, may be combined, separated into separate operations or performed in other orders.

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A music popularity gaming system comprising:
a backend server comprising a non-transitory memory device and a processor coupled to the non-transitory memory device, wherein the non-transitory memory device comprises computer-readable instructions which, when executed by the processor, cause the backend server to:
receive, from a third-party server, information regarding a plurality of songs, the information comprising at least one popularity metric for each song of the plurality of songs during a designated time period;
transmit, to the plurality of computing devices in communication with the backend server, a plurality of song matchups each comprising at least two songs from among the plurality of songs;
receive, from each of the plurality of computing devices, a selection of at least one selected song matchup from among the plurality of song matchups and a selection of a selected song among the at least two songs for the at least one selected transmit, to a plurality of computing devices in communication with the song matchup;
establish a contest between at least two of the plurality of computing devices;
determine a winner of the contest based at least on the selected song having a greater popularity metric than the popularity metric of each other song in the selected song matchup during the designated time period; and
transmit, to the plurality of computing devices, a notification of the winner.

2. The gaming system of claim 1, wherein the popularity metric comprises at least a number of streams for each song of the plurality of songs during a designated time period.

3. The gaming system of claim 1, wherein the popularity metric is selected from the group consisting of stream growth rate over time, playlist inclusion, virality scores derived from social media engagement, and inclusion in editorial or algorithmic playlists.

4. The gaming system of claim 1, wherein the plurality of songs comprises a plurality of newly released songs.

5. The gaming system of claim 1, wherein the computer-readable instructions, when executed by the processor, further cause the backend server to send API calls to API endpoints associated with the third-party server to receive the information regarding the plurality of songs.

6. The gaming system of claim 1, wherein the computer-readable instructions, when executed by the processor, further cause the backend server to:
send, to the third-party server, a request for information regarding artist popularity;
receive, from the third-party server, the information regarding artist popularity;
retain a portion of the information, the portion of the information relating to songs performed by artists having greater than a threshold number of streams per month; and
discard another portion of the information, the another portion of the information relating to songs performed by artists having less than the threshold number of streams per month.

7. The gaming system of claim 6, wherein the portion of the information further relates to songs performed by artists who are projected to release new music within seven days.

8. The gaming system of claim 1, wherein the information is selected from the group consisting of artist name, song title, album title, album cover, release date, and combinations thereof.

9. The gaming system of claim 1, wherein the computer-readable instructions, when executed by the processor, further cause the backend server to:
determine a number of projected streams in the designated time period for each of the plurality of songs; and
automatically generate the plurality of song matchups such that the number of projected streams for each of the at least two songs in each song matchup is similar.

10. The gaming system of claim 1, wherein the computer-readable instructions, when executed by the processor, further cause the backend server to receive, from at least one of the plurality of computing devices, a selection of a plurality of selected song matchups and a confident pick among the plurality of selected song matchups.

11. The gaming system of claim 1, wherein the computer-readable instructions, when executed by the processor, further cause the backend server to receive, from each of the plurality of computing devices, an entry amount.

12. The gaming system of claim 11, wherein the computer-readable instructions, when executed by the processor, further cause the backend server to assign the plurality of computing devices to different contests based on a number of matchups selected and the entry amount selected.

13. The gaming system of claim 1, wherein the computer-readable instructions, when executed by the processor, further cause the backend server to transmit, to at least one the plurality of computing devices in communication with the backend server, a signal comprising full-track playback of a song of the plurality of songs in response to a selection by the at least one the plurality of computing devices.

14. A music popularity gaming method for users competing in a game related to song stream count, the gaming method comprising:
receiving, by a backend server from a third-party server, information regarding a plurality of songs, the information comprising at least one popularity metric for each song of the plurality of songs during a designated time period;
transmitting, to a plurality of computing devices in communication with the backend server, a plurality of song matchups each comprising at least two songs from among the plurality of songs;
receiving, from each of the plurality of computing devices, a selection of at least one selected song matchup from among the plurality of song matchups and a selected song for the at least one selected song matchup;
establishing a contest between at least two of the plurality of computing devices;
determining a winner of the contest based at least on the selected song having a greater popularity metric than the popularity metric of each other song in the selected song matchup during the designated time period; and
transmitting, to the plurality of computing devices, a notification of the winner.

15. The gaming method of claim 14, wherein the popularity metric comprises at least a number of streams for each song of the plurality of songs during a designated time period.

16. The gaming method of claim 14, wherein the popularity metric is selected from the group consisting of stream growth rate over time, playlist inclusion, virality scores derived from social media engagement, and inclusion in editorial or algorithmic playlists.

17. The gaming method of claim 14, further comprising causing a computing device of the plurality of computing devices to playback a song of the plurality of songs in response to an input received by the backend server from the computing device.

18. The gaming method of claim 14, further comprising causing a computing device of the plurality of computing devices to navigate between the plurality of song matchups in response to swipe, tap, or scroll gestures.
